(19) United States
(12) Patent Application Publication
(10) Pub. No.: US 2026/0279748 A1
(43) Pub. Date: Sep. 17, 2026

(54) ION PUMP WITH MONITORING SYSTEM

(71) Applicant: Agilent Technologies, Inc., Santa Clara, CA (US)

(72) Inventors: Tiziano Isoardi, Torino (IT); Paolo Manassero, Torino (IT); Luca Bonmassar, Torino (IT); Sara Drovandi, Torino (IT); Marco Marzot, Torino (IT); Paolo Vassallo, Torino (IT)

(21) Appl. No.: 19/676,624

(22) Filed: May 13, 2026

Related U.S. Application Data
(63) Continuation-in-part of application No. 19/388,260, filed on Nov. 13, 2025.

(30) Foreign Application Priority Data
Nov. 13, 2024 (EP) 24212738.9
May 11, 2026 (EP) 26178024.1

(51) Int. Cl. H01J 41/12

(52) U.S. Cl. CPC H01J 41/12

(57) ABSTRACT

An ion pump, preferably a vacuum pump operating at ultra-high vacuum, comprises an electron trap, preferably a Penning cell, configured to generate an electron plasma. The ion pump further comprises a monitoring system configured to measure a parameter of or relating to the electron plasma. Based on the measurement of the parameter, the monitoring system determines whether the ion pump is in an ON state or an OFF state. In the ON state the electron plasma is generated. In the OFF state no electron plasma is generated.

### CROSS-REFERENCE TO RELATED APPLICATIONS

The present application is a continuation-in-part of U.S. patent application Ser. No. 19/388,260, filed on Nov. 13, 2025; which claims the benefit of European Patent Application No. EP 24212738.9, filed on Nov. 13, 2024; and further claims the benefit of European Patent Application No. EP 26178024.1, filed on May 11, 2026, each of which are incorporated herein by reference in its entirety.

### TECHNICAL FIELD

The present disclosure relates to an ion pump used for creating a vacuum and a method of operating an ion pump employing the monitoring system.

### BACKGROUND

An ion pump is a device able to create and maintain high-vacuum conditions within an environment. The ion pump operation is based on one or more Penning cells, which, as described in more detail below, use a combination of electric and magnetic fields to confine electrons and start ionization and getter pumping processes.

A conventional ion pump 1, shown in FIG. 1, comprises a vacuum casing 2 which accommodates at least one anode 3, consisting of a plurality of hollow cylindrical pumping cells 4, and at least one cathode 5, consisting of plates 5a, 5b, for example made of titanium, located at the opposite ends of the cells 4.

The ion pump 1 further comprises a device (e.g., voltage source) 6, suitable for applying to the anode 3 an electric potential higher than the electric potential at the cathode 5, and magnets 7 placed outside the casing 2, at the opposite ends of the cells 4, and capable of producing a magnetic field oriented parallel to the axes of the cells 4 (as indicated by arrow B in FIG. 1). The anode 3, cathode 5 and magnets 7 define the one or more Penning cells.

During operation, when an electric potential difference (voltage) (typically from 3 to 10 kV) between the anode 3 and the cathode 5 is applied, an intense electric field is generated between the cells 4 of the anode 3 and the cathode 5, this resulting in the emission of electrons from the cathode 5. The electric field, combined with the magnetic field generated by the magnets 7, makes it possible to trap, within the cells 4, the electrons emitted by the cathode 5, thereby creating an electron plasma that is used to ionize the gas molecules present within the environment to be evacuated.

In particular, when the gas molecules enter the cells 4, the plasma electrons collide with these molecules, thereby ionizing them. Because of the electric field, the positive ions resulting from the ionization are attracted towards the cathode 5, leaving the corresponding electrons, left within the cells 4, available for further ionization of the other gas molecules. In this respect, the presence of the magnets 7 for generating the magnetic field allows imparting helical trajectories to electrons, thereby increasing the length of the paths of such electrons between cathode 5 and the anode 3 and, therefore, the possibility of collision and corresponding ionization of the gas molecules present within the cells 4.

Positive ions, meanwhile, reach the cathode 5 and collide with the surface of the cathode 5. The collision of positive ions with the titanium plates 5a and 5b of the cathode 5 causes the phenomenon of sputtering, i.e., the emission of titanium atoms from the cathode 5. The atoms, by covering the inner surfaces of the ion pump 1, create an active titanium film which chemically traps the gas molecules. This mechanism is referred to as pumping at the anode or getter pumping.

As is known, ion pumps are commonly used in ultra-high vacuum (UHV) systems, because they can reach pressures lower than 10⁻¹¹ mbar. Unlike other UHV pumps or conventional mechanical pumps, ion pumps do not have any moving parts and do not require oil or other lubricants. For this reason, ion pumps do not risk contaminating the environments in which they operate, require little maintenance and do not generate vibrations, whereby they constitute an ideal solution for all those applications and production processes that require a clean environment and high-precision control, in both research and industry.

Furthermore, ion pumps are closed pumps, they do not have any foreline. In fact, an ion pump keeps inside all the pumped gas. Therefore, whatever is pumped by an ion pump will remain in it. This avoids the risk of venting the system to which the ion pump is connected. In addition, an ion pump does not require a backing pump during operation, but only at start-up since the ion pump cannot be started at atmospheric pressure.

### SUMMARY

It is an object of the invention to provide an improved monitoring of ion pumps. The object is solved by the independent claim(s). Further embodiments are shown by the dependent claim(s).

A substantially linear relationship exists in ion pumps between pressure and electric current, which means that as the pressure inside the ion pump decreases, the electric current between the anode and the cathode also decreases. To increase the performance of an ion pump at different operating pressures, it is preferable to supply such ion pump with different electric potentials. More specifically, to increase the performance of an ion pump at low operating pressures, it is preferable to supply such ion pump with a lower potential (e.g., 3 kV), which leads to correspondingly having a very low electric current between the anode and the cathode. When the electric current level is below the minimum reading value of the reading scale on the device that powers the ion pump, it can be difficult to tell whether the ion pump is operating at low pressure or has switched off accidentally, which means that the ion pump is not pumping any longer even if a voltage difference is still being applied between the pump electrodes (i.e., even if the ion pump is turned on).

When the ion pump reaches very low-pressure conditions, there may not be enough residual gas molecules to be ionized, thus resulting in the generation of further free electrons. As a result, the electron plasma is switched off and the ion pump stops pumping, despite the voltage difference applied between the pump electrodes (the pump anode and the pump cathode). This condition might occur because the ion pump has worked correctly and has been reaching its intrinsic limit pressure value. If the pressure subsequently rises again (due to either internal or external factors), the ion pump may not immediately start pumping again autonomously. Instead, a pressure rise of several orders of magnitude takes place before the electron plasma is triggered again and the pumping action resumes. By way of example, if an ion pump accidentally switches off when the pressure reaches 10⁻¹² mbar, the pumping action could not autonomously resume until the pressure rises to 10⁻⁸ mbar. Therefore, if the ion pump accidentally switches off and no corrective action is taken, the user has to deal with a pressure much higher than expected when the ion pump autonomously resumes pumping. For larger ion pumps, it may be advantageous to restart the pump at a pressure (e.g. a little bit) lower than 1⁻⁸ mbar

A similar scenario might occur when the ion pump is started at very low-pressure conditions.

Advantageously, the monitoring system according to embodiments of the present disclosure may allow the ON or OFF state of the ion pump to be determined even in conditions of extremely low electric current, lower than the detectability threshold of the commonly used state-of-the-art reading scales, thereby making the monitoring system particularly suitable also for ion pumps operating at low pressure (and thus at low current).

According to an exemplary embodiment of the present invention, an ion pump, preferably a vacuum pump operating at ultra-high vacuum, comprises an electron trap, preferably a Penning cell, configured to generate an electron plasma, and further comprises a monitoring system configured to measure a parameter of or relating to the electron plasma and, based on the measurement of the parameter, to determine whether the ion pump is in an ON state or an OFF state, wherein in the ON state the electron plasma is generated and in the OFF state no electron plasma is generated. This allows reliably detecting loss of pumping caused by plasma extinction even when the ion pump remains energized, and this permits improved operational confidence and faster corrective action at very low pressures where the main ion current may be too small to be read accurately by conventional instruments.

In a preferred embodiment, the parameter measured by the monitoring system is an electromagnetic parameter. This permits determining the ON/OFF state by evaluating signals and/or field-related effects that are characteristic for plasma presence, which can be particularly robust at ultra-high vacuum and can be implemented without relying on the main ion current measurement, thereby improving sensitivity and operational confidence at very low pressures.

In a preferred embodiment, the electromagnetic parameter is an electrostatic parameter and preferably comprises at least one of an electrical potential, an electrical voltage between ground or an anode of the electron trap and a potential within the electron plasma, and an electrical current between ground or an anode of the electron trap and a potential within the electron plasma. This allows the plasma state to be inferred directly from plasma-induced changes of potential distribution and charge transport, and this permits reliable ON/OFF determination even when the pumping current between anode and cathode is below the detectability threshold of commonly used reading scales.

In a preferred embodiment, the monitoring system comprises a probe for measuring the electrostatic parameter, wherein the probe preferably reaches into the electron plasma for probing the electrostatic parameter within the electron plasma. This allows obtaining a strong, localized measurement signal that closely follows the actual plasma condition in the pumping cell, and this permits increased detection fidelity and improved response time for detecting plasma loss and initiating corrective action.

In a preferred embodiment, the electromagnetic parameter comprises at least one of a plasma-induced RF signal and a frequency-specific emission. This allows detecting dynamic electromagnetic signatures that are characteristic of collective electron motion in the plasma, and this permits a non-contact or low-intrusion sensing approach that can improve long-term reliability and reduce wear or contamination risks.

In a preferred embodiment, the monitoring system comprises at least one of an antenna, a resonator, and an impedance shift arrangement for measuring the electromagnetic parameter. This allows detecting plasma presence via coupling of the plasma to an electromagnetic structure and/or via plasma-induced changes in impedance or resonance behaviour, and this permits robust sensing without direct electrical contact to the plasma while maintaining good sensitivity.

In a preferred embodiment, the parameter is selected from: an electromagnetic parameter comprising a dielectric parameter, preferably an electron-density-dependent dielectric parameter; an impedance parameter, preferably a change in impedance; a secondary electron emission at an electrode of the electron trap; an optical emission from the electron plasma; a magnetic field perturbation caused by currents in the electron plasma; and an acoustic or mechanical parameter, preferably related to a micro-vibration of the ion pump. This allows implementing the operational-state determination with a sensing modality that best fits the mechanical and electrical constraints of a given ion pump design, and this permits flexible integration, optional redundancy by combining multiple parameters, and improved robustness of state detection across different operating regimes and pump configurations.

The ion pump according to embodiments of the present disclosure comprises at least one anode and at least one cathode between which an electric potential difference (voltage) is applied. The ion pump is capable of taking on or assuming an ON state in which the electric potential difference applied between the at least one anode and the at least one cathode, in combination with the magnetic field in which the ion pump is immersed, generates an electron plasma. The ion pump is capable of taking on or assuming an OFF state in which no electron plasma is generated despite the electric potential difference applied between the electrodes.

When an ion pump of the Penning type is energized, and electron plasma may be formed within at least one pumping cell if residual gas molecules are ionized. The plasma comprises free electrons and ions confined by the combined action of an electric field applied between an anode and one or more cathodes and a magnetic field aligned with the pumping cell. The presence or absence of this plasma directly corresponds to whether the ion pump is in an operative pumping state.

An operational state of the ion pump can be determined by sensing at least one electromagnetic property of the plasma present within the pumping cell. Said electromagnetic property arises exclusively from the existence and collective behavior of free charge carriers and therefore differs fundamentally between plasma on and plasma off conditions.

When the plasma is present, confined electrons form a negative space charge region within the anode volume. This space charge partially shields the electric field generated by the anode and modifies the electric potential distribution inside the pumping cell. The plasma therefore establishes a plasma specific potential that is distinct from the potential applied to the anode by the power supply.

A probe arranged within the pumping cell or in close proximity to the anode is electrically coupled to this plasma modified potential. Under plasma on conditions (ON state), the probe interacts with the plasma and assumes an electrical potential influenced by the plasma potential and by sheath formation at the probe surface. This allows the monitoring system to measure an electrostatic parameter, e.g. using a probe to measure an electrical voltage and/or current. The voltage measured at the probe differs from the voltage measured when the plasma is absent, in which case the electric field is substantially unshielded and the potential distribution is determined primarily by electrode geometry.

In addition or as an alternative, the presence of plasma influences a current flowing to or from the probe. This probe current is determined by the flux of charged particles reaching the probe surface and by secondary electron effects, both of which occur only when free charge carriers are present in the pumping cell. Measurement of the probe voltage and/or probe current therefore provides a direct indication of whether plasma is present in the pumping cell and thus whether the ion pump is pumping.

The plasma formed inside the pumping cell exhibits a finite electrical conductivity due to the motion of free electrons and ions. This conductivity enables charge transport within the cell and between electrodes, even when the resulting ion current is too small to be measured directly by the pump controller.

Electrical parameters associated with this conductive behavior, such as effective resistance or current carrying capability between conductive elements, differ markedly between plasma ON and plasma OFF states. Monitoring such parameters therefore constitutes sensing of an electrical property of the plasma and enables determination of the operational state of the ion pump independently of conventional ion current measurement.

The plasma acts as an electrically active medium with frequency dependent dielectric properties. In particular, the presence of free electrons modifies the effective permittivity and impedance in the region of the pumping cell.

When a conductive structure, sensor, or resonant element is arranged in proximity to the pumping cell, the plasma loads said structure electrically. This loading alters measurable electrical quantities, such as impedance, capacitance, loss factor, or resonance frequency, compared to conditions in which no plasma is present. Detection of such changes therefore represents determination of an electrical property of the plasma and provides a further means of identifying whether the ion pump is on (ON state) or off (OFF state).

In the plasma ON state, electrons confined within the pumping cell undergo characteristic collective motions as a consequence of the combined electric and magnetic fields. These motions include magnetron motion around the anode, cyclotron motion about magnetic field lines, and axial oscillation along the cell axis. The collective motion of the electrons generates time varying electromagnetic fields at characteristic frequencies, which do not occur in the absence of plasma.

An antenna arranged in proximity to the pumping cell is electromagnetically coupled to these plasma generated fields. When the antenna is configured or tuned to be responsive to one or more characteristic frequencies associated with the electron motion, an electrical signal is induced in the antenna while the plasma is present. In the plasma OFF state, such time varying electromagnetic fields are substantially absent, and no corresponding signal is detected.

This allows measuring time varying electromagnetic parameters preferably by using an antenna-based sensing.

Accordingly, detection of a signal induced in the antenna constitutes measurement of a dynamic electrical property of the plasma and enables determination of the operational state of the ion pump without direct electrical contact with the plasma.

The electromagnetic properties of the plasma that may be used for determining whether the ion pump is on or off include, individually or in any combination:
electrostatic properties such as plasma potential, floating potential, sheath voltage, or electric field distribution;
current related and conductive properties arising from charge transport by free charge carriers;
dielectric and impedance related properties affecting nearby electrical structures; and
time varying electromagnetic properties associated with collective electron motion and plasma oscillations.

Because these electromagnetic properties exist only when a plasma is present within the pumping cell, monitoring at least one such electrical parameter provides a reliable indication of whether the ion pump is operating, even under ultra-high vacuum conditions in which conventional ion current measurement is impractical.

In a preferred embodiment, the monitoring system is configured for determining, based on the measurement of the parameter, whether the ion pump is in an ON state or an OFF state by comparing the measured parameter with at least one of: a threshold value for the parameter, a reference value for the parameter, and a previously measured value for the parameter.

In a preferred embodiment, the ion pump comprises a controller configured to control the voltage source and/or the monitoring system. This permits automated evaluation of the measured parameter(s), consistent application of decision logic for determining the ON/OFF state, and coordinated control actions, thereby allowing more reliable operation, improved diagnostics and data logging, and easier integration into a larger vacuum system control architecture.

In a preferred embodiment, the ion pump comprises a restart system configured to generate an electric discharge inside the ion pump when the ion pump is in the OFF state, wherein the restart system comprises at least one electron emitter arranged inside the ion pump and configured to generate the electric discharge. This allows the ion pump to be actively re-ignited when plasma extinction occurs at very low pressure, which permits avoiding long recovery times associated with waiting for the pressure to rise by several orders of magnitude and thereby reduces non-productive time and improves availability of ultra-high vacuum conditions.

In a preferred embodiment, the voltage source configured to apply the electric potential difference between the at least one anode and the at least one cathode is a first voltage source, and the restart system comprises a second voltage source configured to apply an electric potential to the electron emitter effective to generate the electric discharge. This permits independently optimizing normal pump operation and the restart function, which allows targeted, efficient discharge generation while maintaining stable pumping conditions and can improve reliability and controllability of the restart process.

In a preferred embodiment, a controller IS configured to control an operation of the at least one electron emitter, wherein the voltage source configured to apply the electric potential difference between the at least one anode and the at least one cathode is a first voltage source, the restart system comprises a second voltage source configured to apply an electric potential to the electron emitter effective to generate the electric discharge, and the ion pump comprises a controller configured to control an operation of the second voltage source:

In a preferred embodiment, the at least one cathode comprises at least two cathode plates, at least one of the at least two cathode plates is arranged at one side of the at least one anode, at least one other of the at least two cathode plates is arranged at another side of the at least one anode opposite to the one side, and the at least one electron emitter is arranged at one or more of the at least two cathode plates.

According to an exemplary embodiment of the present invention, a method for operating an ion pump, preferably a vacuum pump operating at ultra-high vacuum, is provided, wherein the ion pump comprises an electron trap, preferably a Penning cell, configured to generate an electron plasma. The method comprises measuring a parameter of or relating to the electron plasma. The method further comprises determining, based on the measurement of the parameter, whether the ion pump is in an ON state or an OFF state, wherein in the ON state the electron plasma is generated and in the OFF state no electron plasma is generated. This allows monitoring and maintaining the pumping state even under operating conditions in which conventional ion current measurement is impractical, which permits timely corrective action and improved stability of vacuum-dependent processes.

According to preferred embodiments, determining, based on the measurement of the parameter, whether the ion pump is in an ON state or an OFF state comprises comparing the measured parameter with at least one of: a threshold value for the parameter, a reference value for the parameter, and a previously measured value for the parameter

According to preferred embodiments, the ion pump may comprise a restart system. As described above, it is essential for the user to be aware, even at very low-pressure and current conditions, whether the ion pump is still pumping or has switched off, so that in the latter case the user can take corrective actions. In the event that the monitoring system described herein detects that the ion pump is in the OFF state, the restart system generates an electric discharge within the ion pump, thereby increasing the probability of restart of the ion pump itself, i.e., increasing the probability of restoring the ON state. The restart system comprises at least one electron emitter, arranged inside the ion pump and capable of generating an electric discharge to cause switching-on of the ion pump (i.e., generation of electron plasma within the ion pump).

In an embodiment, the at least one electron emitter is located near the at least one cathode so as to maximize the probability of generating the electric discharge, while simultaneously reducing the time required to achieve the switching-on.

In this case, too, the restart system is particularly advantageous when applied in a low-pressure ion pump. Indeed, in low-pressure ion pumps, the likelihood of spontaneous generation of an electric discharge capable of causing switching-on of the ion pump is very low and numerous attempts are often necessary before a restart is obtained, this resulting in a lengthening of non-productive time.

According to this further aspect of the present disclosure, a method of operating an ion pump is also provided comprising the steps of: providing a restart system as described above, monitoring the ON/OFF state of the ion pump, if it is detected that the ion pump is in the OFF state, activating the restart system to generate an electric discharge within the ion pump.

In summary, the invention relates to sensors and sensing arrangements for ion pumps, in particular Penning-type ion pumps used in high- and ultra-high-vacuum systems, with the purpose of determining whether the ion pump is effectively operating (i.e. pumping) or not.

In the prior art, ion pumps operate based on a Penning trap principle in which a plasma of electrons is sustained by static electric and magnetic fields, generating an ion current that is proportional to background gas pressure. At very low pressures and optimized low operating voltages, the resulting ion current becomes extremely small and may no longer be reliably measurable. As a consequence, existing pump controllers cannot unambiguously determine whether the plasma is present or extinguished, even though the pump is electrically energized.

Embodiments of the invention allow to detect the presence or absence of plasma inside the ion pump independently of the measurable ion current, by sensing physical effects that are directly associated with plasma generation within the pump cell. This may enable a reliable determination of whether the ion pump is actually operating, even in the absence of a measurable ion current and without requiring an external pressure gauge. This allows timely detection of pump malfunction and enables corrective actions, such as attempting a restart, thereby preventing undetected loss of pumping performance.

One implementation uses a floating voltage probe positioned inside or near the cylindrical anode of the ion pump. When plasma is present, the electron cloud shields the electric field, resulting in a lower internal voltage compared to the plasma-off state; this voltage difference is detected by the probe.

An alternative implementation uses an antenna placed inside or outside the anode structure and tuned to characteristic plasma frequencies (such as magnetron, cyclotron, or axial frequencies). Detection of a plasma-related signal at these frequencies indicates that the plasma, and thus pumping action, is present. The probe or antenna can be installed in a single cell of a multi-cell ion pump array.

### BRIEF DESCRIPTION OF THE DRAWINGS

Further features and advantages of the present disclosure will become more evident from the following detailed description of embodiments of the present disclosure, which is given by way of non-limiting examples with reference to the accompanying drawings.

FIG. 1 shows an ion pump of known type.

FIG. 2 shows a sectional view of a portion of the ion pump according to an embodiment of the present disclosure.

FIG. 3 shows a schematic view of an ion pumping system according to an embodiment of the present disclosure.

FIGS. 4A and 4B illustrate embodiments for measuring an electromagnetic parameter as the parameter.

### DETAILED DESCRIPTION

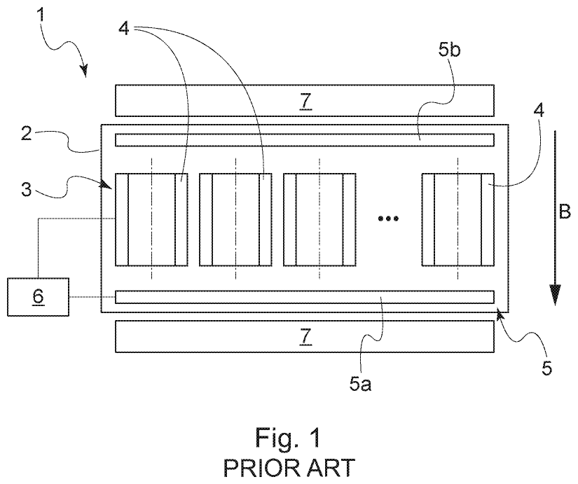

Ion pumps are typically based on an electron trap, preferably a Penning cell, which are devices that leverage a plasma of electrons to ionize the background gas. A static electromagnetic field traps the electrons and accelerates the ions towards one of the cathodes, creating an ion current proportional to the background gas pressure. For performance optimization at low pressure (p<1e-10 mbar), the preferred supply voltage is 3 kV, which leads to a small ion current. At low pressure and low voltage, the plasma can switch off, and the ion pump stops pumping. In the structure of the prior art as e.g. outlined with respect to FIG. 1, Due to low ion current the pump controller cannot tell if the plasma is on or off (even when the plasma is on the current is too low to be measured), meaning that the pump could be supplied with voltage but not pumping.

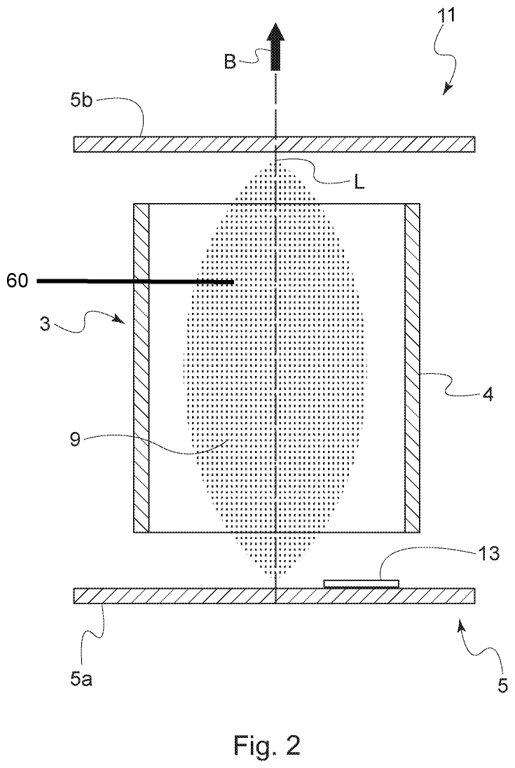

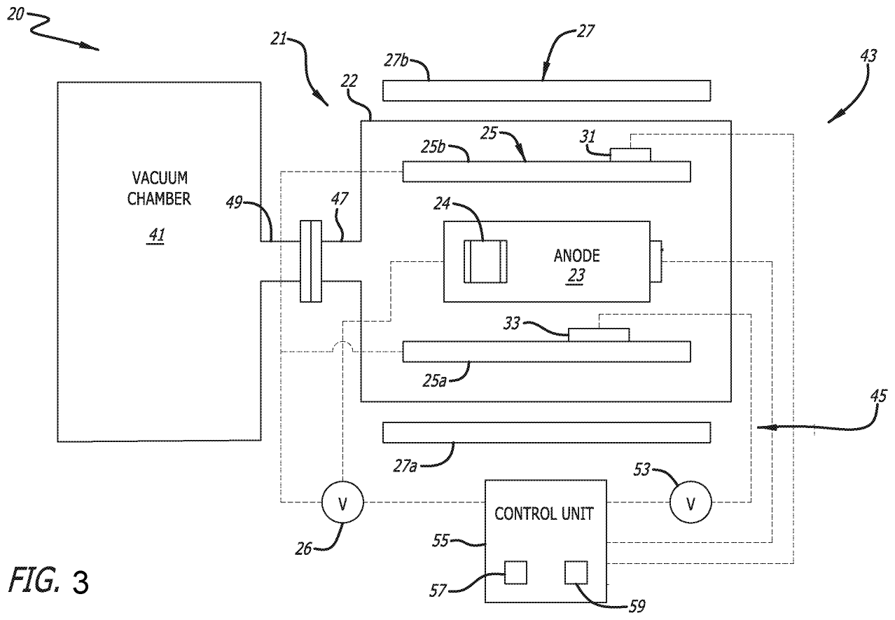

FIG. 2 shows a schematic representation of a Penning cell 11 providing an electron trap as a portion of an ion pump 21 (shown in FIG. 3) according to the present disclosure. The general structure of the Penning cell 11 according to the present disclosure is substantially identical as shown in FIG. 1, and for this reason the same reference numerals as those used in FIG. 1 will be used to indicate identical or equivalent components. Similarly to conventional ion pumps, the Penning cell 11 according to the present disclosure comprises:
a vacuum casing 2 (FIG. 1);
at least one anode 3 disposed (positioned) in the vacuum casing 2 and consisting of a plurality of hollow cylindrical pumping cells 4 (for the sake of simplicity, the longitudinal section of only one cell 4 has been shown in FIG. 2), each pumping cell 4 arranged (or extending) along a longitudinal cell axis L between a first axial side of the pumping cell 4 and a second axial side of the pumping cell 4;
at least one cathode 5, consisting of at least two cathode plates, namely a first cathode plate 5a and a second cathode plate 5b, where the first cathode plate 5a is disposed (positioned) near the first axial sides of the pumping cells 4 and the second cathode plate 5b is disposed (positioned) near the second axial sides of the pumping cells 4;
a device (e.g., voltage source, or potential difference supply) 6 (FIG. 1) configured to apply an electric potential difference (voltage) between the at least one anode 3 and the at least one cathode 5; and
at least two magnets 7 (FIG. 1) disposed (positioned) outside the vacuum casing 2, where a first magnet 7 of the at least two magnets 7 is disposed on the same side of the pumping cells 4 as the first cathode plate 5a and a second magnet 7 of the at least two magnets 7 is disposed on the same side of the pumping cells 4 as the second cathode plate 5b, and the magnets 7 are configured (positioned, oriented, etc.) to generate a magnetic field oriented parallel to the longitudinal cell axes L of the respective pumping cells 4.

The at least two cathode plates 5a, 5b of the cathode 5 are located at the opposite ends of the pumping cells 4 of the anode 3 and are substantially perpendicular to the longitudinal cell axes L of the pumping cells 4. The pumping cells 4 and the cathode plates 5a, 5b are immersed in the magnetic field, the direction of which, represented by arrow B in FIG. 2, is substantially parallel to the longitudinal cell axes L.

During operation, when an electric potential difference (voltage) (typically from 3 to 10 kV) between the anode 3 and the cathode 5 is applied, an intense electric field is generated between the cells 4 of the anode 3 and the one or more cathodes 5a and 5b, this resulting in the emission of electrons from the cathodes 5. The electric field, combined with the magnetic field generated by the magnets 7, makes it possible to trap, within the cells 4, the electrons emitted by the cathode 5, thereby creating an electron plasma 9 that is used to ionize the gas molecules present within the environment to be evacuated.

FIG. 3 shows a schematic view of a vacuum pumping system 20 according to the present disclosure. The vacuum pumping system 20 includes an ion pump 21 and a vacuum chamber 41. The ion pump 21 may be configured, for example, according to any of the embodiments disclosed herein. Accordingly, in the illustrated example, the ion pump 21 includes a vacuum casing (pump casing) 22, at least one anode (assembly) 23, at least one cathode (assembly) 25, a (first) voltage source (potential difference source or supply) 26, at least one magnet (assembly) 27, a monitoring system 43, and an optional restart system 45, as described herein.

The ion pump 21 fluidly communicates the vacuum chamber 41 via a pump inlet 47 of the ion pump 21 coupled to a port 49 of the vacuum chamber 41, whereby gas molecules flow from the interior of the vacuum chamber 41 into the interior of the ion pump 21 (i.e., the vacuum casing 22). Fluid flow through the pump inlet 47 and/or the port 49 may be controlled by one or more fluidic valves (not shown) of any appropriate type if desired or needed. The vacuum chamber 41 may be any enclosed space to be evacuated by operation of the ion pump 21 and may be part of any apparatus or system that requires such evacuated space.

The anode 23 may include one or more hollow, cylindrical pumping cells (anode cells) 24 as described herein. The cathode 25 may include one or more cathode plates, for example, at least two cathode plates 25a, 25b, disposed (or positioned, arranged, mounted) on opposite sides of the anode 23, in particular on opposite open sides of the pumping cell(s) 24, as described herein. The (first) voltage source 26 may be any electrical circuitry or hardware configured to apply a controllable electric potential difference between the anode 23 and the cathode 25, as described herein. The circuitry associated with the anode 23, cathode 25, and (first) voltage source 26 may include one or more electrical grounds (e.g., grounding points, terminals, planes, etc.) as appropriate and as appreciated by the skilled artisan. The magnet 27 may include two or more magnets, for example, at least two magnets 27a, 27b disposed (or positioned, arranged, mounted) at (on or near) the respective outer sides of the cathode plates 25a, 25b, as described herein. In the present context, the term “outer side” is relative to the anode 23. That is, the outer side of each magnet 27a, 27b is the side that faces away from the corresponding side of the anode 23. In the illustrated example, the magnets 27a, 27b are located outside the vacuum (pump) housing 22.

The monitoring system 43 is configured to measure a parameter of or relating to the electron plasma 9 as explained in more detail below. Based on the measurement of the parameter, the monitoring system 43 can determine whether the ion pump is in an ON state or an OFF state, wherein in the ON state the electron plasma 9 is generated, and in the OFF state no electron plasma 9 is generated.

Turning back to FIG. 2, a first embodiment for measuring the parameter by use of a probe 60 is schematically shown. The probe 60 is configured for measuring as the parameter an electromagnetic parameter, namely an electrostatic parameter of or relating to the electron plasma 9. The probe 60 is reaching into the electron plasma 9 as schematically indicated in FIG. 2, so that the probe 60 can measure or sense the electrostatic parameter at a spatial position within the electron plasma 9. The electrostatic parameter can be an electrical potential, an electrical voltage preferably between ground or the anode 23 of the Penning cell 11 and a potential within the electron plasma 9, and an electrical current preferably between ground or the anode 23 of the Penning cell 11 and a potential within the electron plasma 9.

The spatial location or position wherein the probe 60 is sensing the electrostatic parameter within the electron plasma 9 should not be too crucial in most applications but, of course, certain less suitable positions should be avoided, e.g. as resolved from a tuning activity to identify the most suitable position. Preferably, the sensing position of the probe 60 within the electron plasma 9 is selected to be away from the middle and closer but not too close to the anode 23, e.g. as schematically indicated in FIG. 2.

The probe 60 can be embodied e.g. by a piece of metal, such as a wire, which may be isolated against the anode 23, in particular when the probe 60 may reach through the anode 23. The geometry of the probe 60 may preferably be selected to affect the electron plasma 9 only to a minimum, as generally known in the art.

The voltage range measured by the probe 60 may be in the range of tens of Volt, for example between 10 and 100 V, dependent on the specific configuration and geometry of the Penning cell 11.

Instead of measuring voltage, the probe 60 may also be applied for measuring an electrical current, as readily known in the art. Dependent on the specific configuration and geometry of the Penning cell 11, currents in the range of micro or milli ampere may be measured.

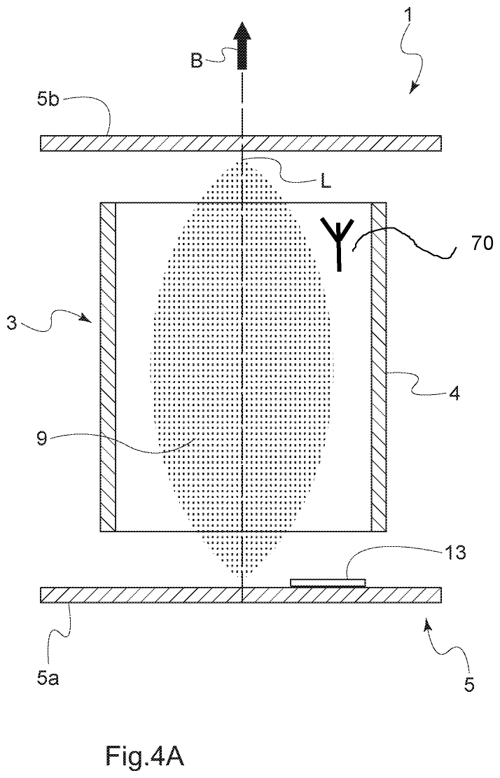

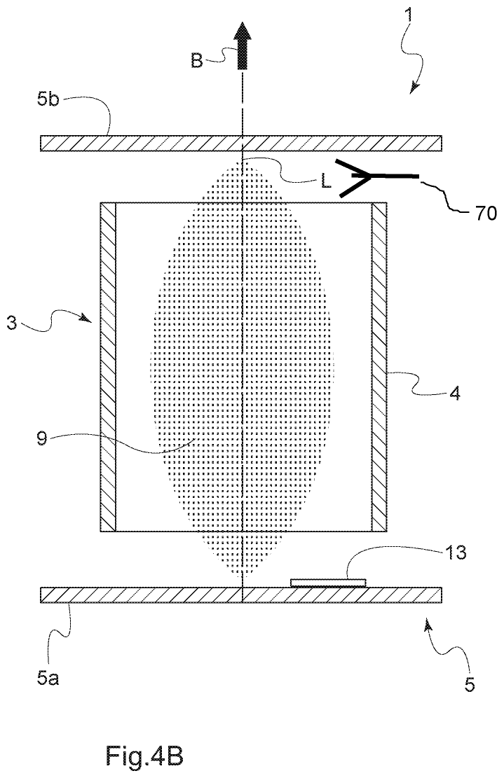

FIG. 4A illustrates a second embodiment for measuring an electromagnetic parameter as the parameter. Instead of the probe 60 for measuring an electrostatic parameter, as in FIG. 2, an antenna 70 is provided for measuring the parameter. In the second embodiment, the parameter is a plasma-induced RF signal or may also be a frequency-specific emission. In alternative embodiments, instead of or in addition to the antenna 70, a resonator or an impedance shift may be applied for measuring the electromagnetic parameter.

In the embodiment of FIG. 4A, the antenna 70 is provided and spatially located within or inside the cell 4, as schematically illustrated. This allows avoiding an electromagnetic shielding effect, for example resulting from the cell 4.

FIG. 4B illustrates a third embodiment an electromagnetic parameter. With respect to the embodiment of FIG. 4A, the antenna 70 in FIG. 4B is spatially located between the cell 4 and one of the cathodes 5, here close to cathode 5b.

The antenna 70 in both embodiments of FIGS. 4A and 4B may allow measuring electromagnetic signals from the electron plasma 9 in a frequency range of about gigahertz (GHz) and at a magnitude of some volts, again dependent on the specific configuration and geometry of the Penning cell 11.

Other parameters of the electron plasma 9 or relating to the electron plasma 9 may be measured instead or in addition to the electromagnetic parameter (e.g. as illustrated with respect to FIGS. 2 and 4), which, however, further details here. For example, a dielectric parameter, an impedance, or permittivity change, optical emission (e.g. using a photomultiplier), magnetic perturbation, and acoustic a mechanical vibration signals may be measured.

Based on the measurement of the parameter, the monitoring system 43 determines whether the ion pump 21 is in an ON state or an OFF state, wherein in the ON state the electron plasma 9 is generated and in the OFF state no electron plasma 9 is generated. The monitoring system 43 makes it possible to determine accurately whether the ion pump 21 is running (is “on”) or is switched off. This allows the monitoring system to determine the ON/OFF state of the ion pump 21 even when the ion pump 21 is operating under low-pressure conditions.

For example in the embodiment of FIG. 2, the probe 60 measures in the ON state of the ion pump 21 a voltage difference in the range of tens of Volt with respect to an OFF state of the ion pump 21. In the OFF state, the probe 60 measures the static electrical field within the cell 4. In the ON state, the electron plasma 9 modifies the static electrical field, and the probe 60 thus measures the electrical field modified by the electron plasma 9. Based on the voltage difference measured by the probe 60, the monitoring system 43 can drawback whether the electron plasma 9 is generated (ON state) or not (OFF state).

Similar in the embodiments of FIG. 4, the antenna 70 measures and electromagnetic signal only in the ON state, while there is no electromagnetic signal measurable by the antenna 70 OFF state. Based on the difference in the electromagnetic signal as measured by the antenna 70, the monitoring system 43 can draw back whether the electron plasma 9 is generated (ON state) or not (OFF state).

Generally speaking, the monitoring system 43 receives a measured value for the paragraph meter (e.g. a measured voltage difference from the probe 60) and can then determine, based on such measured value of the parameter, whether the ion pump 21 is in an ON state or an OFF state. In one embodiment, the monitoring system 43 compares the measured value of the parameter with a threshold value for the parameter, and if the measured value exceeds the threshold value it can draw back on whether the ion pump 21 is in and ON state or in an OFF state. In an example, when the monitoring system 43 determines that the measured voltage difference from the probe 60 has decreased by a certain value, e.g. 30 V, beyond a reference value for an OFF state of the ion pump 21, i.e. when there is no electron plasma, such decrease likely results from a shielding provided by the electron plasma, and the monitoring system 43 concludes that the ion pump 21 is in an ON state.

Alternatively, instead of a reference value for the parameter, a previously measured value for the parameter, e.g. from a previous measurement of the parameter in the ion pump 21, can be used.

In the event that the ion pump 21 is in the OFF state and is to be brought back to the ON state without waiting for the pressure to rise until the ion pump 21 autonomously resumes pumping, the (optional) restart system 45 is configured to generate an electric discharge inside the ion pump 21 to thereby increase the probability of restoring the ON state, as described herein. For this purpose, the restart system includes at least one electron emitter 33 disposed (or positioned, arranged, mounted) inside the ion pump 21 (in particular, in the interior of the vacuum housing 22) and a (second) voltage source 53. The electron emitter(s) 33 is/are configured to generate the electric discharge in response to being activated (powered) by the (second) voltage source 53. In the illustrated example, the electron emitter 33, or at least one of the electron emitters 33 provided, is disposed at or on (e.g., mounted near or to) the cathode 25, such as one of the cathode plates 25a, 25b. The (second) voltage source 53 is configured to apply a voltage potential to the electron emitter(s) 33 at a magnitude effective for causing electron emission by an appropriate mechanism as appreciated by the skilled artisan. The (second) voltage source 53 may be configured to apply a voltage (electric potential difference) between the electron emitter(s) 33 and another part of the associated circuitry (e.g., electrode, electrical ground, etc.) as appreciated by the skilled artisan.

The ion pump 21 may also include a controller (or system controller, control unit, computing device, etc.) 55. The controller 55 may schematically represent one or more modules (or units, components, etc.) configured (or programmed) for controlling, monitoring and/or timing various functional aspects of the vacuum pumping system 20 including, for example, the operations of one or more components of (or communicating with) the ion pump 21, as described herein. In the present context, the term “control” denotes wired or wired communication with a given, controlled/controllable component. Depending on the type of component, such “control” may entail monitoring the operation of the component, timing the operation of the component, adjusting the operation of the component, sending control signals to the component, receiving output signals from the component (e.g., measurement or detection signals), and/or otherwise communicating with the component, as appreciated by the skilled artisan. All or part of the controller 55 (such as may be disposed in an electronics box) may be located directly at the ion pump 21 or separately (or remotely) from the ion pump 21.

For all such purposes, the controller 55 may be in wired or wireless communication with one or more of the components of the vacuum pumping system 20, as depicted by dashed lines in FIG. 3, and may include any suitable combination of hardware, firmware, software, etc., including one or more electronics-based processors 57 and memories 59, as appreciated by persons skilled in the art. For example, the controller 55 may include a non-transitory (or tangible) computer-readable medium that includes non-transitory instructions stored thereon, that when executed on a processor, control or perform one or more of the steps of any of the method implementations disclosed herein. In FIG. 3, the schematically illustrated controller 55 is representative of all such components described in this paragraph that are associated with the controller 55.

One or more modules of the controller 55 may be, or be embodied in, one or more devices located outside or separate from the vacuum pumping system 20, for example, a computer workstation, desktop computer, laptop computer, portable computer, tablet computer, handheld computer, mobile computing device, personal digital assistant (PDA), smartphone, remote server, etc. One or more modules of the controller 55 may communicate with one or more other modules via one or more busses or other types of communication lines or wireless links, as appreciated by persons skilled in the art. In FIG. 3, the schematically illustrated controller 55 is representative of all such components described in this paragraph that are associated with the controller 55.

The processor(s) 57 of the controller 55 may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The memory or memories 59 (e.g., volatile and/or non-volatile types, e.g., RAM and/or ROM) may be configured to store data and/or software. Stored data may be organized, for example, in one or more databases or look-up tables. The controller 55 may also include one or more device drivers for controlling one or more types of user interface devices and providing an interface between the user interface devices and components of the controller 55 communicating with the user interface devices. Such user interface devices may include user input devices (e.g., keyboard, keypad, touch screen, mouse, joystick, trackball, and the like) and user output devices (e.g., display screen, printer, visual indicators or alerts, audible indicators or alerts, and the like). In various implementations, the controller 55 may be considered as including one or more of the user input devices and/or user output devices, or at least as communicating with them. In FIG. 3, the schematically illustrated controller 55 is representative of all such components described in this paragraph that are associated with the controller 55.

In some implementations, the controller 55 may also include one or more types of computer programs or software contained in the memory (or memories) 59 and/or on one or more types of non-transitory (or tangible) computer-readable media. One or more devices of the controller 55 may be configured to receive and read (and optionally write to) the memory (or memories) 59 and/or computer-readable media. The computer programs or software may contain non-transitory instructions (e.g., logic instructions) for controlling or performing various operations of the vacuum pumping system 20, such as the operations of the various devices described herein. The computer programs or software may include system software and application software. System software may include an operating system (e.g., a Microsoft Windows® operating system) for controlling and managing various functions of the controller 55, including interaction between hardware and application software. In particular, the operating system may provide a graphical user interface (GUI) displayable via a user output device of the controller 55, and with which a user may interact with the use of a user input device of the controller 55. Application software may include software configured to control or execute various operations of the vacuum pumping system 20, and/or some or all of the steps of any of the methods disclosed herein. In FIG. 3, the schematically illustrated controller 55 is representative of all such components described in this paragraph that are associated with the controller 55.

The controller 55 may also include an ion pump controller (or control module) configured to control the operation of one or more components of the ion pump 21 (e.g., ON/off states, power supplied, etc.). The controller 55 may also include one or more sensor interfaces configured to receive and process feedback (e.g., measurement) signals received from one or more sensors/meters/data loggers provided with the ion pump 21, such as the probe 60 or the antenna 70, first voltage source 26, second voltage source 53, pressure sensors, actively controlled or monitored fluidic valves, etc., as described above. For example, the sensor interfaces may be embodied in different pieces of firmware or other electronic circuitry that are part of a microcontroller of the controller 55. The sensor interfaces may communicate with the ion pump controller and other components of the controller 55 as needed to provide effective control of various operations of the ion pump 21 and/or the performance of any of the methods described herein. The firmware or other electronic circuitry embodying the ion pump controller also may be provided with the same microcontroller that includes the sensor interfaces, or the firmware or other electronic circuitry may be provided with separate hardware of the controller 55. The controller 55 may also include a data acquisition module (or DAQ) configured to further condition or process the signals received by the sensor interface(s) as needed for preparing data to be analyzed by the controller 55. In FIG. 3, the schematically illustrated controller 55 is representative of all such components described in this paragraph that are associated with the controller 55.

According to an embodiment of the present disclosure, a restart system can also be provided within the Penning cell 11. In the event that the Penning cell 11 is in the OFF state and is to be brought back to the ON state without waiting for the pressure to rise until the Penning cell 11 autonomously resumes pumping, it is possible to resort to the restart system, which generates an electric discharge in order to increase the probability of restoring the ON state. The restart system comprises at least one electron emitter 13, arranged inside the Penning cell 11, such as at one of the plates 5a of the at least one cathode 5 of the Penning cell 11, to further increase the probabilities of generation of the electric discharge.

According to this embodiment of the present disclosure, the method of operating the Penning cell 11 further comprises the steps of:
providing a restart system as described above;
if it is detected (or determined) that the Penning cell 11 is in the OFF state, activating the restart system to generate an electric discharge within the Penning cell 11.

It should be noted that it is also possible to provide that the restart system reacts independently of the monitoring system described above and is activated in the event that the OFF state of the Penning cell 11 is detected in another manner and with other means.

It will be evident to the person skilled in the art that the embodiments described above in detail should in no way be understood in a limiting sense, and that numerous modifications and variants are possible without thereby departing from the scope of protection as defined by the appended claims.

For instance, even if in the above disclosure reference has been made to an ion pump having a so-called “diode configuration” in which the cathode is grounded and a positive electric potential is applied to the anode, the present disclosure may also be applied to an ion pump having a so-called “triode configuration”, in which the anode and the pump casing are grounded and a negative electric potential is applied to the anode.

It will be understood that one or more of the processes, sub-processes, and process steps described herein may be performed by hardware, firmware, software, or a combination of two or more of the foregoing, on one or more electronic or digitally controlled devices. The software may reside in a software memory (which may be represented, e.g., by the memory 59 schematically depicted in FIG. 3) in a suitable electronic processing component or system such as, for example, the controller 55 schematically depicted in FIG. 3. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module (which may be represented, e.g., by the processor 57 schematically depicted in FIG. 3). The processing module may include, for example, one or more microprocessors, general purpose processors, combinations of processors, digital signal processors (DSPs), application specific integrated circuits (ASICs), field-programmable gate array (FPGAs), etc. Further, the schematic diagrams in the drawing figures describe a logical division of functions having physical (hardware and/or software) implementations that are not limited by architecture or the physical layout of the functions. The examples of systems, apparatuses, devices, components, modules, or sub-modules described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the controller 55 schematically depicted in FIG. 3), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system (or apparatus, or device). A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, apparatus, device, component, module, or sub-module to a second system, apparatus, device, component, module, or sub-module along a signal path between the first and second systems, apparatuses, devices, components, modules, or sub-modules. The signal paths may include physical, electrical, magnetic, electromagnetic, electrochemical, optical, wired, or wireless connections. The signal paths may also include one or more additional systems, apparatuses, devices, components, modules, or sub-modules between the first and second systems, apparatuses, devices, components, modules, or sub-modules.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic, or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

| Ref. | Description |
|---|---|
| 1 | Ion pump (prior art) |
| 2 | Vacuum casing (prior art) |
| 3 | Anode (prior art) |
| 4 | Pumping cell(s) (prior art) |
| 5 | Cathode (prior art) |
| 5a | Cathode plate |
| 5b | Cathode plate |
| 6 | Device (e.g., voltage source) (prior art) |
| 7 | Magnet(s) (prior art) |
| 9 | Electron plasma |
| 11 | Electron trap/Penning cell |
| 13 | Electron emitter (Penning cell embodiment) |
| 20 | Vacuum pumping system |
| 21 | Ion pump |
| 22 | Vacuum casing/pump casing/vacuum housing |
| 23 | Anode (assembly) |
| 24 | Pumping cell(s)/anode cell(s) |
| 25 | Cathode (assembly) |
| 25a | Cathode plate |
| 25b | Cathode plate |
| 26 | (First) voltage source/potential difference source |
| 27 | Magnet(s) (assembly) |
| 27a | Magnet |
| 27b | Magnet |
| 33 | Electron emitter (restart system) |
| 41 | Vacuum chamber |
| 43 | Monitoring system |
| 45 | Restart system |
| 47 | Pump inlet |
| 49 | Port (of vacuum chamber) |
| 53 | (Second) voltage source |
| 55 | Controller |
| 57 | Processor(s) |
| 59 | Memory/memories |
| 60 | Probe |
| 70 | Antenna |

1. An ion pump, preferably a vacuum pump operating at ultra-high vacuum, comprising:
an electron trap, preferably a Penning cell, configured to generate an electron plasma, and
a monitoring system configured to measure a parameter of or relating to the electron plasma, and, based on the measurement of the parameter, determine whether the ion pump is in an ON state or an OFF state, wherein in the ON state the electron plasma is generated, and in the OFF state no electron plasma is generated.

2. The ion pump according to claim 1, wherein the measured parameter is an electromagnetic parameter.

3. The ion pump according to claim 2, wherein the electromagnetic parameter is an electrostatic parameter, preferably at least one of an electrical potential, an electrical voltage preferably between ground or an anode of the electron trap and a potential within the electron plasma, and an electrical current preferably between ground or an anode of the electron trap and a potential within the electron plasma.

4. The ion pump according to claim 3, wherein the monitoring system comprises a probe for measuring the electrostatic parameter, wherein the probe is preferably reaching into the electron plasma for probing the electrostatic parameter within the electron plasma.

5. The ion pump according to claim 2, wherein the electromagnetic parameter is at least one of a plasma-induced RF signal and a frequency-specific emission.

6. The ion pump according to claim 5, wherein the monitoring system comprises at least one of an antenna, a resonator, and an impedance shift for measuring the electromagnetic parameter.

7. The ion pump according to claim 1, wherein the parameter is one of:
an electromagnetic parameter of: a dielectric parameter, preferably an electron density-dependent dielectric parameter, and an impedance parameter, preferably a change in impedance;
a secondary electron emission at an electrode of the electron trap;
an optical emission from the electron plasma;
a magnetic field perturbation caused by currents in the electron plasma;
an acoustic or mechanical parameter, preferably related to a micro-vibration of the ion pump.

8. The ion pump according to claim 1, wherein the electron trap comprises:
at least one anode;
at least one cathode;
a voltage source configured to apply an electric potential difference between the at least one anode and the at least one cathode;
at least two magnets configured to immerse the at least one anode and the at least one cathode in a magnetic field,
wherein the ion pump is configured to assume the ON state in which the electric potential difference is applied, in combination with the magnetic field, to generate the electron plasma, and an OFF state in which no electron plasma is generated despite the electric potential difference being applied.

9. The ion pump according to claim 1, comprising at least one of the following:
the monitoring system is configured for determining, based on the measurement of the parameter, whether the ion pump is in an ON state or an OFF state by comparing the measured parameter with at least one of: a threshold value for the parameter, a reference value for the parameter, and a previously measured value for the parameter;
a controller configured to control the voltage source and/or the monitoring system.

10. The ion pump according to claim 1, comprising a restart system configured to generate an electric discharge inside the ion pump when the ion pump is in the OFF state, the restart system comprising at least one electron emitter arranged inside the ion pump and configured to generate the electric discharge.

11. The ion pump according to claim 10, comprising at least one of the following:
the voltage source configured to apply the electric potential difference between the at least one anode and the at least one cathode is a first voltage source, and the restart system comprises a second voltage source configured to apply an electric potential to the electron emitter effective to generate the electric discharge;
a controller configured to control an operation of the at least one electron emitter, wherein the voltage source configured to apply the electric potential difference between the at least one anode and the at least one cathode is a first voltage source, the restart system comprises a second voltage source configured to apply an electric potential to the electron emitter effective to generate the electric discharge, and the ion pump comprises a controller configured to control an operation of the second voltage source;
the at least one cathode comprises at least two cathode plates, at least one of the at least two cathode plates is arranged at one side of the at least one anode, at least one other of the at least two cathode plates is arranged at another side of the at least one anode opposite to the one side, and the at least one electron emitter is arranged at one or more of the at least two cathode plates.

12. A method for operating an ion pump, preferably a vacuum pump operating at ultra-high vacuum, comprising an electron trap, preferably a Penning cell, configured to generate an electron plasma, the method comprises:
measuring a parameter of or relating to the electron plasma, and
determining, based on the measurement of the parameter, whether the ion pump is in an ON state or an OFF state, wherein in the ON state the electron plasma is generated, and in the OFF state no electron plasma is generated.

13. The method according to claim 12, comprising at least one of:
determining, based on the measurement of the parameter, whether the ion pump is in an ON state or an OFF state comprises comparing the measured parameter with at least one of: a threshold value for the parameter, a reference value for the parameter, and a previously measured value for the parameter;
the ion pump comprises a restart system configured to generate an electric discharge inside the ion pump when the ion pump is in the OFF state; and
during the monitoring, if it is determined that the ion pump is in the OFF state, activating the restart system to generate the electric discharge.

14. The method according to claim 13, wherein the restart system comprises at least one electron emitter arranged inside the ion pump and configured to generate the electric discharge; wherein preferably
the voltage source configured to apply the electric potential difference between the at least one anode and the at least one cathode is a first voltage source, and the restart system comprises a second voltage source configured to apply an electric potential to the electron emitter effective to generate the electric discharge.

15. A software program or product, preferably stored on a data carrier, for controlling or executing the method of claim 12, when run on a data processing system such as a computer.
